(19) United States
(12) Patent Application Publication
(10) Pub. No.: US 2012/0199048 A1
(43) Pub. Date: Aug. 9, 2012

(54) Selectively Configurable Barrier Systems, Wall Assemblies and Related Methods

(76) Inventor: Julie Savalas, Alpharetta, GA (US)

(21) Appl. No.: 13/368,296

(22) Filed: Feb. 7, 2012

Related U.S. Application Data
(60) Provisional application No. 61/440,046, filed on Feb. 7, 2011.

(51) Int. Cl. A47B 96/00; B23P 11/00

(52) U.S. Cl. 108/27; 29/428

(57) ABSTRACT

Disclosed are barrier systems for and methods of retaining articles on or near a surface of an item such as an appliance. In some embodiments, a barrier system includes a plurality of modular wall assemblies joined together by releasable end connector assemblies. The barrier system may be temporarily attached to an item such as an appliance using one or more releasable fasteners. A barrier system attached near the perimeter edge regions of a top surface helps increase the usable space and decrease the risk of articles falling. A barrier catch system releasably attached to a side surface, especially near a door, helps capture falling articles.

### CROSS-REFERENCE TO RELATED APPLICATIONS

This application claims the benefit of U.S. Provisional Application 61/440,046, entitled “Selectively Configurable Barrier Assemblies and Methods,” filed Feb. 7, 2011, which is hereby incorporated herein by reference in its entirety.

### BACKGROUND

Surfaces such as the tops of appliances, cabinets, desks and shelves typically include no way to keep items from falling off the edges. Full and efficient use these top surface, therefore, requires the user to keep items away from the edges. This limitation reduces the effective net space available on the surface. Accordingly, there is a need for improved systems for, and methods of, retaining items on the top surface of appliances and other objects.

Other surfaces, too, such as the side walls of appliances, cabinets, and desks, typically include no way to retain or catch falling items. For example, when such a side wall includes an opening like a door, items may fall during the process of inserting or removing items through the door. Quick and efficient use of such a door is limited by the risk that items may fall to the ground or floor. Accordingly, there is a need for improved systems for, and methods of, retaining items near an opening such as a door.

### SUMMARY OF THE DESCRIBED EMBODIMENTS

A barrier system for an object such as an appliance (e.g., that defines a top surface and a side surface) comprises: (1) a wall assembly comprising a substantially planar barrier extending upwardly from an elongated base; and (2) one or more releasable fasteners that are sized, shaped and positioned to selectively attach the wall assembly to the top surface such that the barrier remains in a plane that is substantially perpendicular to the object's top surface. The barrier system may include a frame that at least partly defines a central portion. The central portion may include a lattice, a net, or a substantially solid panel. In particular embodiments, the one or more releasable fasteners may include at least one fastener selected from the group consisting of magnets, suction cups, releasable adhesives, hook-and-loop fasteners, and clamps. In particular embodiments, the first wall assembly may further comprise: (a) an extension projecting outwardly from the base along a plane that is substantially parallel to the side wall; and (b) a releasable extension fastener adapted to selectively attach the extension to the side wall. The appliance may, for example, be a clothes washer, a clothes dryer, a cooktop, or other appliance.

In particular embodiments, the barrier system further comprises: (1) a second wall assembly comprising a substantially planar second barrier extending upwardly from an elongated second base; (2) one or more releasable second fasteners that are sized, shaped and positioned to selectively attach the second wall assembly to the top surface such that the second barrier remains in a plane that is substantially perpendicular to the top surface; and (3) an end connector assembly positioned between and adapted to releasably connect the first and second wall assemblies. The end connector assembly may further comprise a pivotable connection such that the first and second wall assemblies pivot relative to one another about a substantially vertical axis when connected. The end connector assembly may comprise at least one connector selected from a group consisting of a hinge, a magnet, an elastic band, a releasable adhesive, a hook-and-loop fastener, and an interlocking joint. In particular embodiments, the first and second wall assemblies are selectively attached to the top surface near one or more perimeter edge regions of the top surface such that the assemblies form a substantially continuous barrier around at least a portion of the top surface.

In particular embodiments, the barrier system further comprises: (1) a third wall assembly comprising a substantially planar third barrier extending upwardly from an elongated third base; and (2) one or more releasable third fasteners that are sized, shaped and positioned to selectively attach the third wall assembly to the top surface such that the third barrier remains in a plane that is substantially perpendicular to the top surface; and (3) a second end connector assembly positioned between and adapted to releasably connect the second and third wall assemblies to form a substantially U-shaped arrangement.

In particular embodiments, the barrier system further comprises: (1) a fourth wall assembly comprising a substantially planar fourth barrier extending upwardly from an elongated fourth base; (2) one or more releasable fourth fasteners that are sized, shaped and positioned to selectively attach the fourth wall assembly to the top surface such that the fourth barrier remains in a plane that is substantially perpendicular to the top surface; and (3) a third end connector assembly positioned between and adapted to releasably connect the third and fourth wall assemblies, to form a substantially U-shaped arrangement.

A barrier catch system for an object such as an appliance (that comprises a side surface having a door therein) comprises: (1) an elongated base; (2) a central portion extending outwardly from the elongated base, wherein the central portion is sized and shaped to catch articles that fall during the process of being inserted into or removed from the appliance through the door, and wherein the central portion comprises a basket, a net, a lattice, or a substantially solid panel; and (3) one or more releasable fasteners that are sized, shaped and positioned to selectively attach the elongated base to the side surface beneath the door. The one or more releasable fasteners may be sized, shaped and positioned such that the central portion, when attached, remains in a plane disposed at an acute angle relative to the side surface. The one or more releasable fasteners may comprise at least one magnet. The barrier catch system may further include one or more side walls extending between said elongated base and said central portion. The central portion may be pivotably connected to the base.

A method of providing a selectively configurable barrier near one or more perimeter edge regions of a top surface of an appliance comprises the steps of: (1) providing a first wall assembly having a substantially planar central portion extending upwardly from an elongated base, and wherein the first wall assembly further comprises one or more releasable fasteners that are sized, shaped and positioned to selectively attach the wall assembly to the top surface such that the central portion remains in a plane that is substantially perpendicular to the top surface; (2) providing a second wall assembly having a substantially planar second central portion extending upwardly from an elongated second base, and wherein the second wall assembly further comprises one or more releasable second fasteners that are sized, shaped and positioned to selectively attach the second wall assembly to the top surface such that the second central portion remains in a plane that is substantially perpendicular to the top surface; (3) instructing a user to connect the first and second wall assemblies with an end connector assembly provided and adapted to releasably connect the first and second wall assemblies; and (4) instructing the user to position the first and second wall assemblies near the one or more perimeter edge regions of the top surface in order to form a substantially continuous barrier around at least a portion of the top surface. The step of (4) instructing a user may further comprise the step of providing the end connector assembly with pivotable connection such that the first and second wall assemblies pivot relative to one another about a substantially vertical axis when connected.

A method of providing a selectively configurable barrier may further comprise the steps of: (1) providing a third wall assembly comprising a substantially planar third central portion extending upwardly from an elongate third base, and wherein the third wall assembly further comprises one or more releasable third fasteners that are sized, shaped and positioned to selectively attach the third wall assembly to the top surface such that the third central portion remains in a plane that is substantially perpendicular to the top surface; (2) instructing a user to connect the second and third wall assemblies with a second end connector assembly provided and adapted to releasably connect the second and third wall assemblies; and (3) instructing the user to position the first and second and third wall assemblies adjacent the top surface in order to form a substantially continuous and U-shaped barrier around at least a portion of the top surface.

### BRIEF DESCRIPTION OF THE DRAWINGS

Throughout the description below, reference will be made to the accompanying drawings, which are not necessarily drawn to scale, and wherein:

FIG. 1 is a front perspective view of a barrier system according to a particular embodiment in which the barrier system includes four wall assemblies positioned on a surface, such as the top surface of a clothes washer and dryer.

FIG. 2 is a rear perspective view of the barrier system of FIG. 1.

FIG. 3 is a perspective view of a first side wall assembly, according to a particular embodiment.

FIG. 4 is a close-up bottom perspective view of a lower corner formed by the second rear wall assembly and the second side wall assembly of the barrier system shown in FIG. 1.

FIG. 5 is a top view of the barrier system of FIG. 1 in which the two rear wall assemblies are shown detached. In this figure, dashed lines indicate how the various wall assemblies may be folded together for shipping or storage purposes.

FIG. 6 is top view showing the second end connector assembly of the barrier system shown in FIG. 1.

FIG. 7 is a top view of a first end connector assembly of the barrier system shown in FIG. 1. In this figure, the first end connector assembly is shown in a partially open orientation.

FIG. 8 is a perspective view of an alternative embodiment of the barrier system of FIG. 1 which includes an alternative embodiment of the base of a first wall assembly.

FIG. 9A is an end view of a first wall assembly according to particular alternative embodiment.

FIG. 9B is an end view of a first wall assembly according to particular alternative embodiment.

FIG. 9C is an end view of a first wall assembly according to particular alternative embodiment.

FIG. 10 is a front perspective view of a barrier catch system according to a particular embodiment in which the system includes a wall assembly positioned on a side wall surface, such as the front face of a clothes washer or dryer.

FIG. 11 is a front perspective view of a barrier system according to an alternative embodiment in which the barrier system includes four wall assemblies positioned on a surface, such as the top surface of a clothes washer and dryer.

FIG. 12 is a front perspective view of a lift-off hinge arrangement that may be used to connect the first and second rear wall assemblies of FIG. 11.

### DETAILED DESCRIPTION OF VARIOUS EMBODIMENTS

Various embodiments will now be described with reference to the accompanying drawings. It should be understood that the inventions described below may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Overview

A barrier system according to a particular embodiment of the invention comprises one or more at least substantially vertical wall assemblies. One or more of the wall assemblies includes a temporary fastener arrangement for releasably attaching the barrier system to a surface, such as the top surface of an appliance or other object. The temporary fastener arrangement is adapted such that, when attached to a substantially horizontal surface, the temporary fastener arrangement: (1) maintains the wall assemblies in a substantially vertical orientation; and (2) maintains the wall assemblies in a substantially fixed orientation relative to the substantially horizontal surface. The temporary fastener arrangement may include one or more temporary fasteners. In particular embodiments, the horizontal surface is a metal surface and the temporary fastener arrangement comprises at least one magnet. For example, the temporary fastener arrangement may include: (1) a first magnet that is disposed adjacent both a bottom surface of the wall assembly and the wall's first lateral side; and (2) a second magnet that is disposed adjacent both a bottom surface of the wall assembly and the wall assembly's second lateral side. In other embodiments, the temporary fastener arrangement may include one or more suction cups, hook and loop fasteners, or the like.

In some embodiments, the temporary fastener arrangement may include only one fastener, or it may include a plurality of fasteners (e.g., two, three, four, five, or more fasteners). For example, the temporary fastener arrangement may include a single, elongated magnet that is attached to the bottom surface of the wall assembly, and that extends at least partially along the length of the wall assembly's bottom surface. In other embodiments, the temporary fastener arrangement includes a plurality of three or more fasteners that may, for example, be spaced substantially evenly (or unevenly) apart along the length of the wall assembly (e.g., along the bottom surface, or another surface, of the wall assembly).

In particular embodiments, the barrier system includes a plurality of wall assemblies (such as those described above) that are attached together via suitable fasteners (e.g., hinges, brackets, hook and loop fasteners, or any other suitable fasteners). This may, for example, facilitate allowing a user to connect the wall assemblies in order to form an at least substantially continuous barrier on a surface.

Barrier systems according to various embodiments are particularly suitable for use in providing a selectively configurable barrier near portions of the perimeter edge of the substantially horizontal metallic top surface of an appliance, filing cabinet, table, desk or shelf. For example, a combination of vertical wall assemblies such as those described generally above may be used to provide a substantially continuous vertical barrier near the side and rear perimeter edge regions of the top surface of a washer/dryer combination. Similarly, an assembly of three such vertical wall assemblies may be used to provide a vertical barrier near the side and rear perimeter edge regions of the top surface of a clothes washer or dryer. In particular embodiments, the barrier system may be modular, and may allow a user to selectively reconfigure and operatively install the wall assemblies adjacent a horizontal surface without tools.

Various barrier systems are described in greater detail below.

### Structure of an Exemplary Barrier System

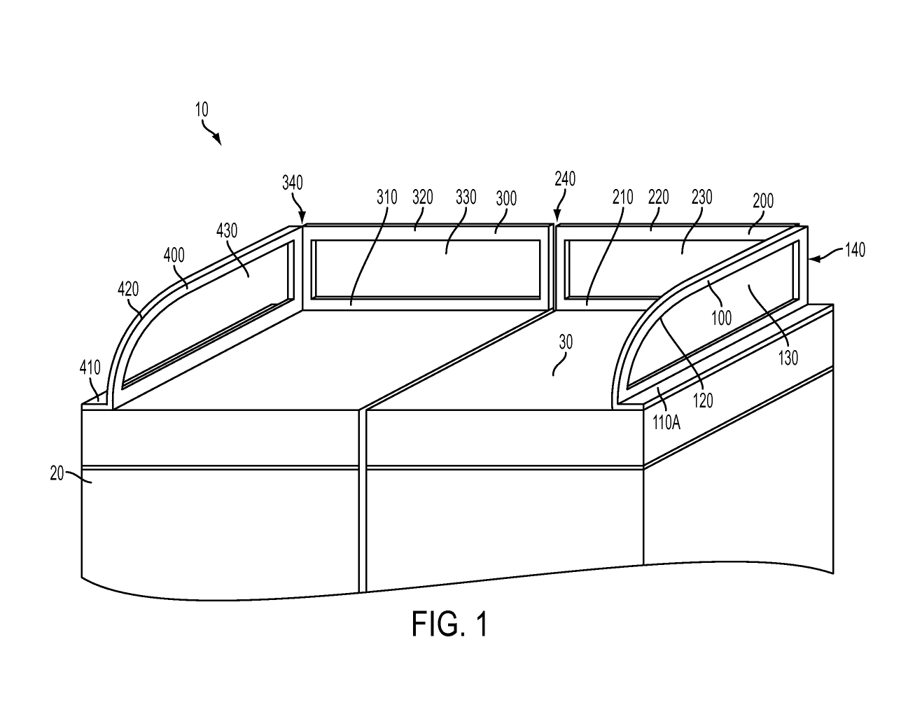

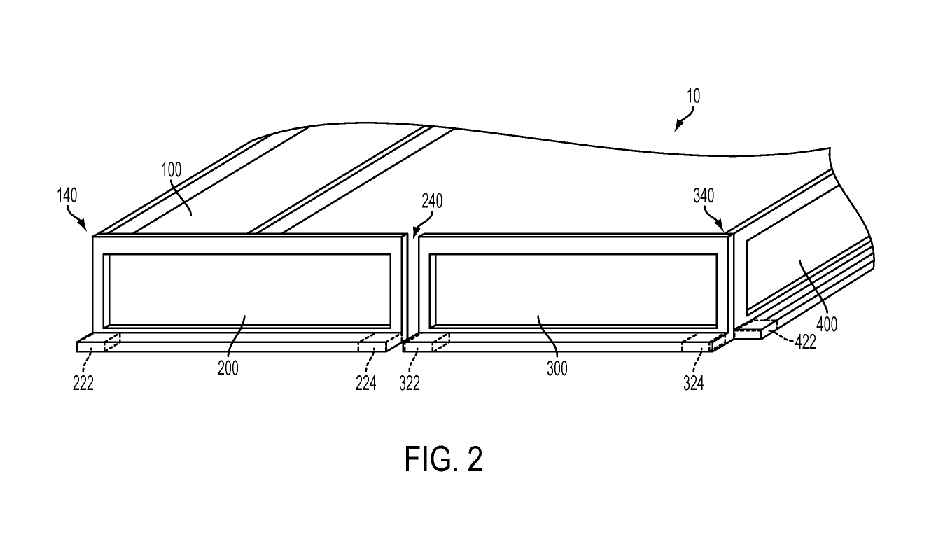

An exemplary barrier system 10 according to a particular embodiment is shown in FIG. 1. As may be understood from this figure, the barrier system 10 includes four wall assemblies 100, 200, 300, 400. These wall assemblies include two side wall assemblies 100, 400, and two rear wall assemblies 200, 300. The respective structures of the side and rear wall assemblies 100, 200, 300, 400 are discussed in greater detail below.

Side Wall Assemblies

As may be understood from FIG. 1, the first side wall assembly 100 includes a frame 120 and an elongated base 110. The base 110 and frame 120 may cooperate to form an angle of between about eighty and about one hundred degrees (e.g., about ninety degrees). Alternatively, the wall assembly 100 may be constructed so that sits at any angle relative to the surface 30; for example, such that it leans inwardly or outwardly, relative to the surface. The side wall assembly 100 further optionally includes a substantially planar central portion 130 that may, for example, extend between the frame's respective interior surfaces. The central portion 130 may be solid or partially open, rigid or elastic, smooth or textured, opaque or partially transparent, and may include one or more layers or intermediate surfaces. The central portion 130 may comprise, for example, latticework, a net, a pattern of intermediate rails, or any otherwise partially open arrangement of materials. The side wall assembly 110 may be constructed of plastic, fabric, metal, nylon fabric, corn resin, bamboo resin, wood, vinyl covered wire or any other suitable material.

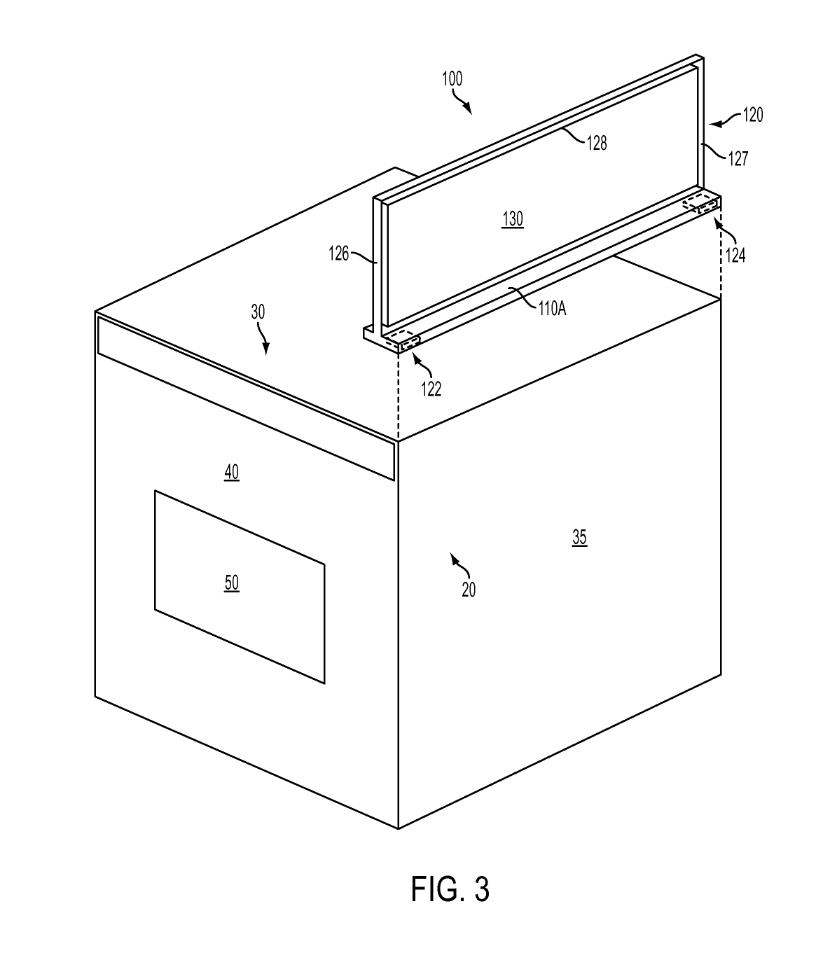

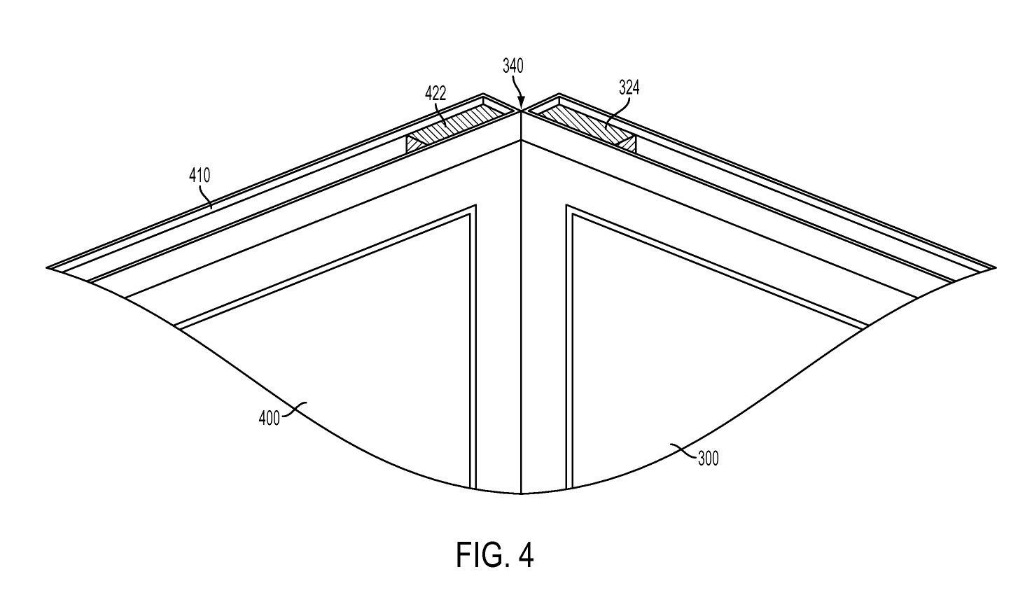

As may be understood from the embodiment illustrated in FIG. 3, the base 110A may include an arrangement of temporary fasteners 122, 124, such as magnets, hook-and-loop fasteners, or suction cups. Such temporary fasteners 122, 124 are adapted to allow users to selectively reposition and reinstall the side wall assembly 100 relative to the horizontal surface 30 without using tools. In the embodiment shown in FIG. 3, the temporary fastener arrangement includes: (1) a first magnet 122 that is disposed adjacent both a bottom surface of the base 110 and the wall assembly's proximal lateral side; and (2) a second magnet 124 that is disposed adjacent both a bottom surface of the base 110 and the wall assembly's distal lateral side. The first and second magnets 122, 124 may be any suitable magnet, such as a ceramic and/or a rare earth magnet. In other embodiments, the temporary fastener arrangement may include any other suitable combination of one or more magnets.

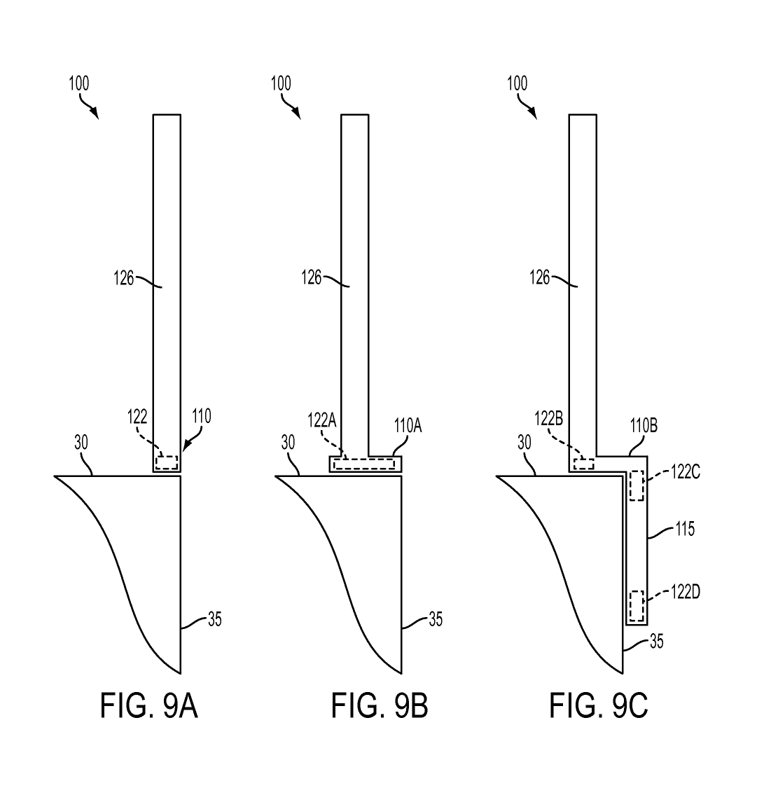

The base 110 may be sized and shaped in order to facilitate the selective attachment, shifting, removal and re-attachment of the frame 120 in various positions. As illustrated in FIGS. 9A, 9B, and 9C, the base 110 may take any of a variety of suitable shapes.

The base 110A illustrated in FIG. 9B (and also in FIG. 3), for example, includes portions that extend laterally relative to the substantially vertical plane of the side wall assembly 100. As shown, the fastener 122A may be sized and shaped to fit within a portion the base 110A. The base, in another aspect, may be sized and shaped differently along different portions of its length. Any combination of shapes and sizes may be used according to a particular purpose and parameters, such as the lateral forces expected, the desired stability, the materials to be retained, the orientation of the surface, and any of a variety of other design parameters.

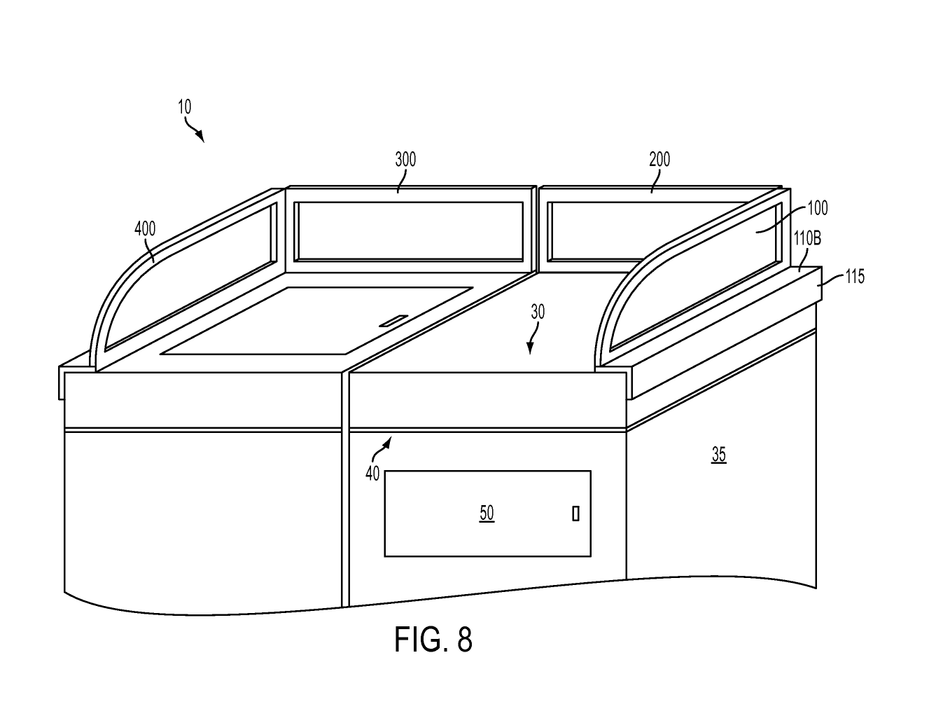

The base 110B illustrated in FIG. 9C, for example, includes a portion that extends laterally relative to the substantially vertical plane of the side wall assembly 100. In a particular embodiment, the wall assembly 110 includes an extension 115 (also illustrated in FIG. 8). The extension 115, as shown, extends along a side wall 35 in order to provide additional stability or support for the wall assembly 110. The extension 115 may include one or more additional releasable fasteners 122C, 122D positioned on the inner side of the extension 115, as shown. It should be understood that, although the arrangement of temporary fasteners is described above as being part of the base 110, the arrangement of temporary fasteners may alternatively be physically separate from and attached adjacent (e.g., to) the base 110 or any other suitable part of the side wall assembly 100. In a particular example, which is shown in FIG. 8 and FIG. 9C, the base 110B is substantially L-shaped and includes a downwardly-extending, substantially planar extension 115. In this embodiment, the base 110B extends at least partially across a corner formed by the top surface 30 and the side surface 35 of the object that is supporting the side wall assembly 100. In a particular embodiment, as shown in FIG. 9C, at least a portion of the temporary fastener arrangement may be positioned on the interior surface of the extension 115. This may further assist in maintaining the wall assembly 100 in a stable, substantially vertical orientation adjacent the object.

It should be further understood that, although the wall assembly's frame 120 is shown in FIG. 1 as having a downwardly sloping proximal end, the frame 120 in other embodiments may be, for example, substantially in the form of a rectangle, a half circle, a triangle, an irregular shape, or any other suitable shape. For example, as shown in FIG. 3, the frame 120 may include a base 110, a post 126, and a top rail 128, and may also include one or more second posts 127. The post 126 may be positioned near the end of the frame 120 (as shown in FIG. 3), near the middle, or at any other location in the frame 120. The post 126 may be narrow or wide, relative to the size and shape of the frame 120.

In some embodiments, the central portion 130 may be sufficiently rigid or otherwise supportive such that the central portion 130 acts like and serves a similar function as a frame 120. In this aspect, a first wall assembly 100 may include a substantially supportive central portion 130 and no discrete frame 120.

As shown in FIG. 1, in particular embodiments, the second side wall assembly 400 may have the same general structure as the first side wall assembly 100.

Rear Wall Assemblies

As may be understood from FIG. 1, in various embodiments, the rear wall assemblies 200, 300 have the same general structure as the first and second side wall assemblies 100, 400. In the embodiment shown, the frames of the first and second rear wall assemblies 200, 300 are substantially rectangular. However, in other embodiments, the rear wall assemblies 200, 300 may be, for example, substantially in the form of a half circle, a triangle, an irregular shape, or any other suitable shape.

End Connector Assemblies

As discussed above, in various embodiments, the barrier system 10 includes a plurality of wall assemblies 100, 200, 300, 400 (such as those described above) that are attached together (or that are adapted to be selectively attached together) via suitable end connector assemblies 140, 240, 340 (e.g., hinges, brackets, hook and loop fasteners, or any other suitable fasteners). This may, for example, facilitate allowing a user to build an at least substantially continuous barrier structure on a surface.

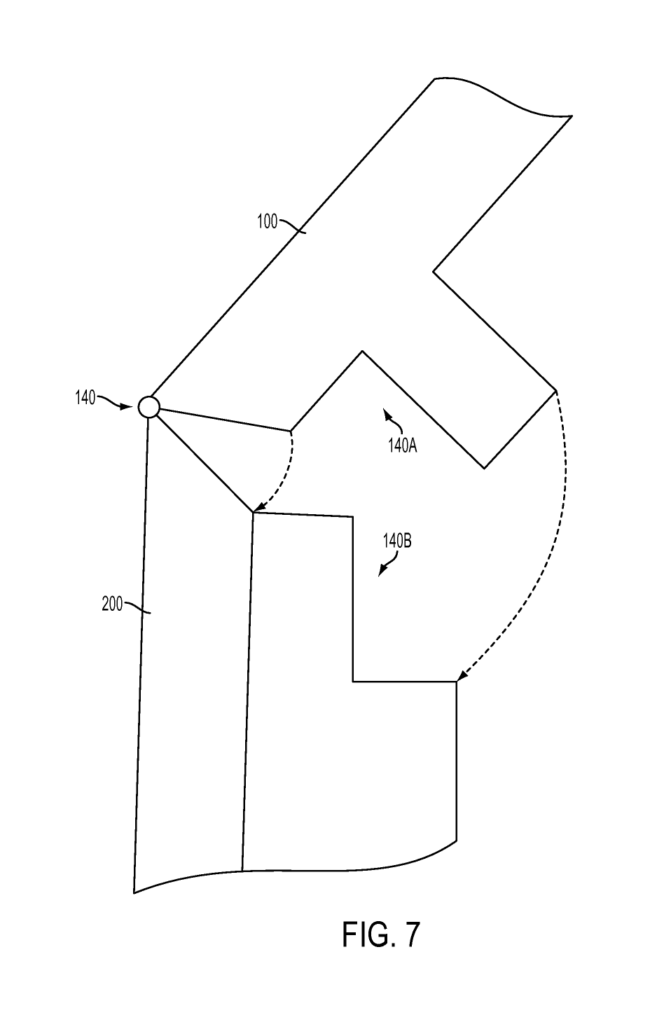

In the embodiment shown in FIG. 1, the proximal end of the first side wall assembly 100 is attached to an end of the first rear wall assembly 200 via a first end connector assembly 140. Similarly, the proximal end of the second side wall assembly 400 is attached to an end of the second rear wall assembly 300 via a second hinge assembly 340. The first and second end connector assemblies 140, 340 may form a pivotable connection that includes, for example, one or more suitable hinges, such as, but not limited to, a piano hinge, a lift-off hinge, a quick-disconnect latching hinge, or a living hinge, such as the living hinge arrangement shown in FIG. 7. The second end connector assembly 140, in the embodiment shown in FIG. 7, includes a mounting edge 140A and a mating edge 140B. The mating edge 140B may by sized and shaped to snap into or otherwise engage the mounting edge 140A. The pivotable connection such as the first end connector assembly 140 shown in FIG. 7 allows the wall assemblies 100, 200 to pivot about an axis that is substantially parallel to the mounting and mating edges.

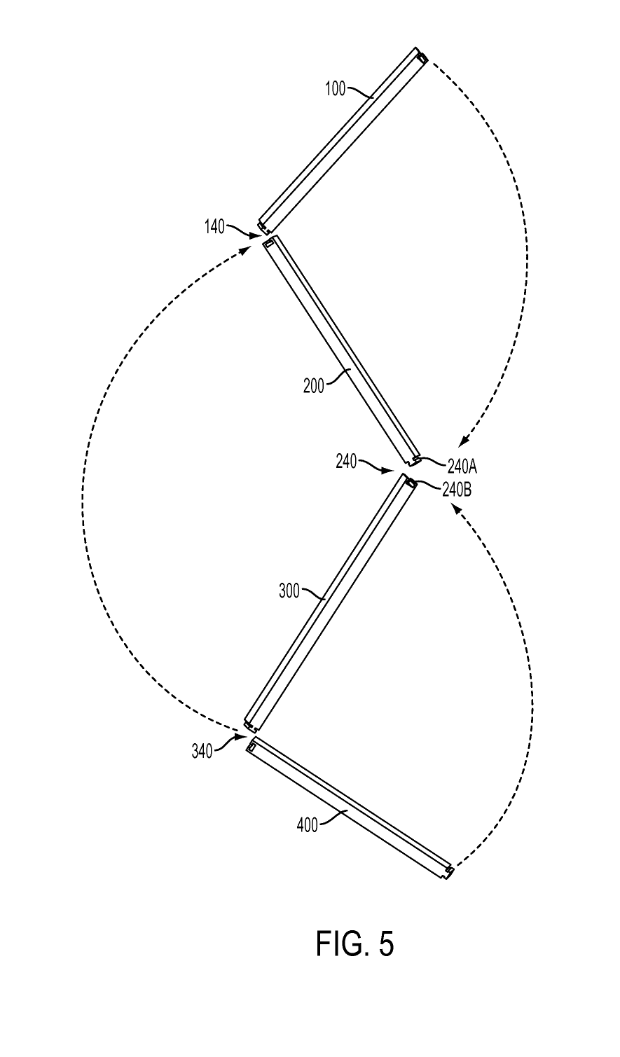

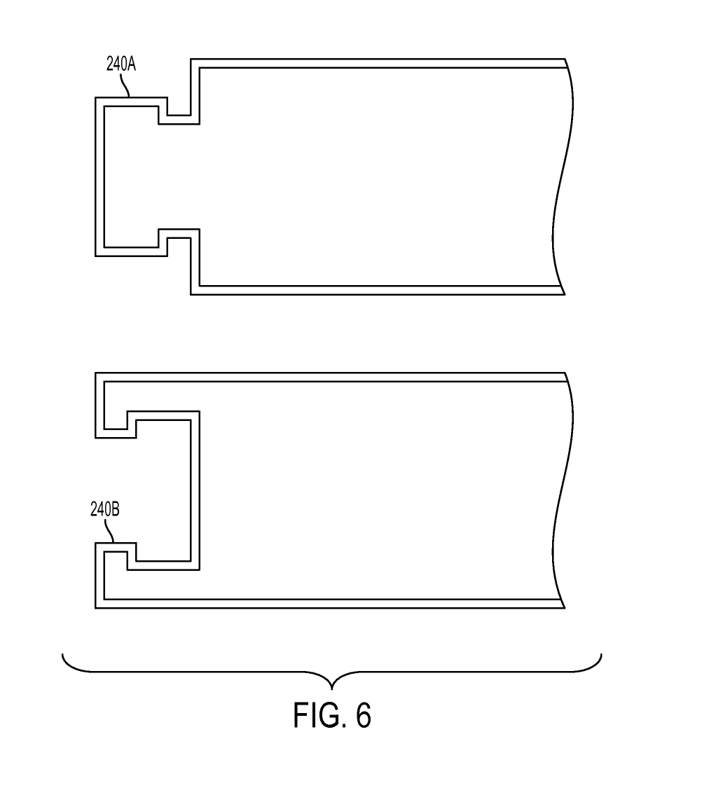

In the embodiment of FIG. 1, the respective proximal lateral ends of the first and second rear wall assemblies 200, 300 are attached together via a second end connector assembly 240, such as the lift-apart frictional fastener illustrated in FIGS. 5 and 6. As shown, the second end connector assembly 240 may include a mounting edge 240A and a mating edge 240B. As illustrated in greater detail in FIG. 6, the mating edge 240B may by sized and shaped to slide into or otherwise engage the mounting edge 240A. For a substantially fixed connection, an end connector assembly like the second end connector assembly 240 shown in FIG. 6 allows the rear wall assemblies 200, 300 to remain substantially within the same plane when attached. In other embodiments, the respective proximal lateral ends of the first and second rear wall assemblies 200, 300 may be attached together via any other suitable type of fastener, such as a suitable hinge (e.g., a lift-off hinge), an adhesive, or a hook-and-loop fastening system.

Alternatively, an end connector assembly may include a releasable connection (including, for example, a pair of magnets, a releasable adhesive, a hook-and-look fastener, an elastic band, or the like) such that the wall assemblies are connected in a relatively flexible and releasable manner.

In various embodiments, one or more of the various wall assemblies 100, 200, 300, 400 may be attached together via end connector assemblies that allow the wall assemblies 100, 200, 300, 400 to be attached to the rest of the barrier system 10 in any of a plurality of different locations. Such fasteners allow the wall assemblies to be selectively rearranged in a modular manner. For example, in an embodiment similar to the embodiment shown in FIG. 1, the first side wall assembly 100 may include a fastener 140 that is adapted to attach the first side wall assembly 100 to either the distal end of the first rear wall assembly 200, or the proximal end of the second rear wall assembly 300. In such an embodiment, the barrier system 10 may be selectively rearranged between: (1) the configuration shown in FIG. 1 (in which the barrier system 10 includes four wall assemblies 100, 200, 300, 400 that extend along the rear and side perimeter edge regions of a horizontal surface, such as the top surface of a side-by-side washer/dryer combination); and (2) a configuration in which the first rear wall assembly 200 is removed and the first side wall assembly 100 is attached to the proximal lateral end of the second rear wall assembly 300 so that the first side wall assembly 100 is spaced apart from, substantially parallel to, and co-facing the second side wall assembly 400. In this embodiment, the barrier system 10 includes three wall assemblies 100, 300, 400 that extend along the rear and side upper perimeter edge regions of a horizontal surface, such as the upper surface of a washer.

### Use of Barrier Systems

The use of a particular embodiment of the barrier system 10 shown in FIG. 1 will now be described. In this embodiment: (1) the first side wall assembly 100 is attached to the first rear wall assembly 200 via a first end connector assembly 140; (2) the second side wall assembly 400 is attached to the second rear wall assembly 300 via a third end connector assembly 340; and (3) the first and second rear wall assemblies 200, 300 are adapted to be attached together via a second end connector assembly 240 such as the lift-apart fastener shown in FIGS. 5 and 6.

In one implementation, the barrier system 10 is packaged and shipped to a customer in a box that is in the form of a substantially rectangular prism. As shown in FIG. 5, before the barrier system 10 may be folded before it is placed in the box. To fold the barrier system 10: (1) the first side wall assembly 100 is rotated about the first end connector assembly 140 until the first side wall assembly 100 is immediately adjacent the first rear wall assembly 200; (2) the second side wall assembly 400 is rotated about the third end connector assembly 340 until the second side wall assembly 400 is immediately adjacent the second rear wall assembly 300; and (3) the four wall assemblies 100, 200, 300, 400 are stacked in a vertical column, placed in the box, and provided to a customer.

When the customer wishes to use the barrier system 10, the customer: (1) removes the folded barrier system 10 from the box; (2) rotates the first side wall assembly 100 about the first end connector assembly 140 until the first side wall assembly 100 and the first rear wall assembly 200 form an angle of about ninety degrees; (3) uses the one or more temporary fasteners (122, 124, for example) on the bottom of the first side wall assembly 100 to attach the first side wall assembly 100 so that it is maintained in a substantially vertical orientation on a horizontal surface (e.g., on the metallic top surface of a washer/dryer assembly) immediately adjacent a first lateral perimeter region of the top surface; (4) uses the one or more temporary fasteners on the bottom of the first rear wall assembly 200 to attach the first rear wall assembly 200 so that it is maintained in a substantially vertical orientation on the top surface immediately adjacent a rear perimeter region of the top surface; (5) uses the one or more temporary fasteners on the bottom of the second side wall assembly 400 to attach the second side wall assembly 400 so that it is maintained in a substantially vertical orientation on the top surface immediately adjacent a second lateral perimeter region of the top surface; and (6) uses the one or more temporary fasteners on the bottom of the second rear wall assembly 300 to attach the second rear wall assembly 300 so that it is maintained in a substantially vertical orientation on the top surface immediately adjacent the rear perimeter region of the top surface. In particular embodiments, as the second rear wall assembly 300 is moved into place immediately adjacent the first rear wall assembly 200, the second rear wall assembly 300 is attached to the first rear wall assembly 200. After the above steps are complete, the barrier system 10 may serve as a substantially continuous barrier around the side and rear perimeter of the horizontal surface.

In a particular example shown in FIG. 1, the horizontal surface is the metallic upper surface of a washer/dryer combination, and the barrier system 10 is attached to the horizontal surface via magnets. This allows an individual to install and selectively reposition the barrier system 10 without tools. As discussed above, in other embodiments, the barrier system 10 may be attached to the horizontal surface via other temporary fasteners, such as suction cups, clamps, or hook-and-loop fasteners.

Because, in various embodiments, the barrier system 10 is attached to the suitable horizontal surface via temporary fasteners, a user may selectively move the barrier system between different horizontal surfaces without tools. For example, the user may move the barrier system from the upper surface of a washer/dryer combination to surround the upper surface of a stove, a metal desk, or any other suitable horizontal surface.

Barrier system according to various embodiments may be used for: (1) keeping laundry in place on top of a washer or dryer; (2) preventing children from touching the burners of a stovetop (in which case, the barrier system may extend around the front and/or sides of a stove's upper surface); (3) keeping papers in place on the upper surface of a filing cabinet; (4) defining a working surface on a metallic desk; or (5) any other suitable purpose.

### Barrier Catch System

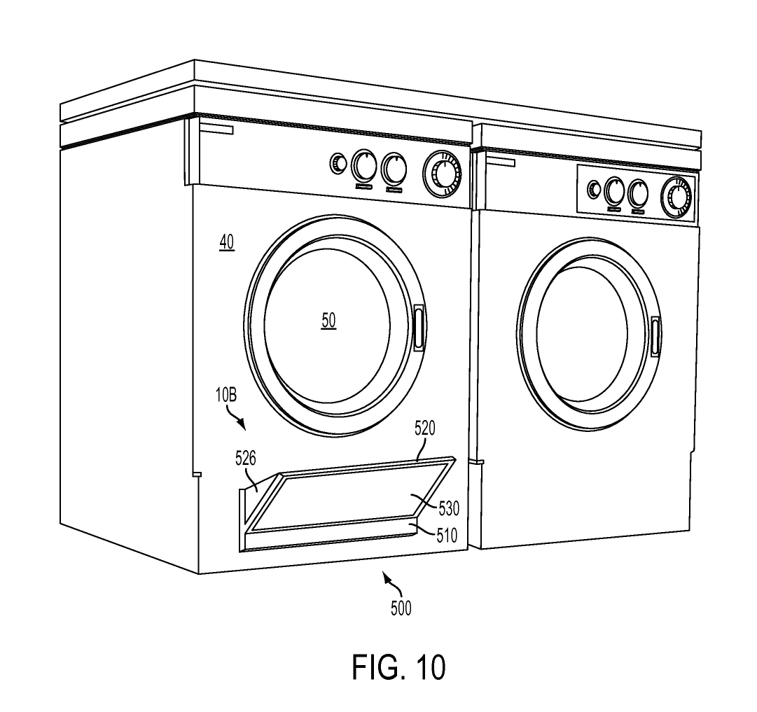

In another embodiment, illustrated in FIG. 10, a wall assembly 500 may be positioned against a side wall or the front face 40 of an appliance. The barrier catch system 10B shown in FIG. 10 may include one wall assembly 500, as shown, or multiple wall assemblies attached using an end connector assembly such as the ones described below. As shown in FIG. 10, the wall assembly 500 may be positioned below an opening such as a door 50. The wall assembly 500 comprises a frame 520 that defines a central portion 530. The frame 520 comprises a base 510 and, optionally, a side wall 526. The wall assembly 500 may include a basket, a net, a lattice, a solid panel, or any suitable material for an intended purpose.

As shown in FIG. 10, the base 510 includes portions that extend laterally along the substantially vertical plane of the front face 40. The frame 520 extends away from the base 510 at an acute angle relative to the front face. The optional side wall 526, as shown, may be sized and shaped to substantially fill the space between the base 510 and the frame 520. In one alternative embodiment, the side wall 526 is constructed of a flexible material and the frame 520 is pivotably connected (by a hinge, for example), so that the frame 520 may be rotated relative to the base 510, toward the front face 40, and stowed when not in use.

The wall assembly 500 includes one or more releasable fasteners (not shown) that are adapted to selectively attach the wall assembly 500 to a surface such as the side wall or front face 40 of an appliance 20. The releasable fasteners may be positioned in the base 510. Any combination of fasteners having different shapes, sizes and strengths may be used according to a particular purpose and other parameters; for example, the expected load, desired stability, durability, cost, or any of a variety of other design parameters.

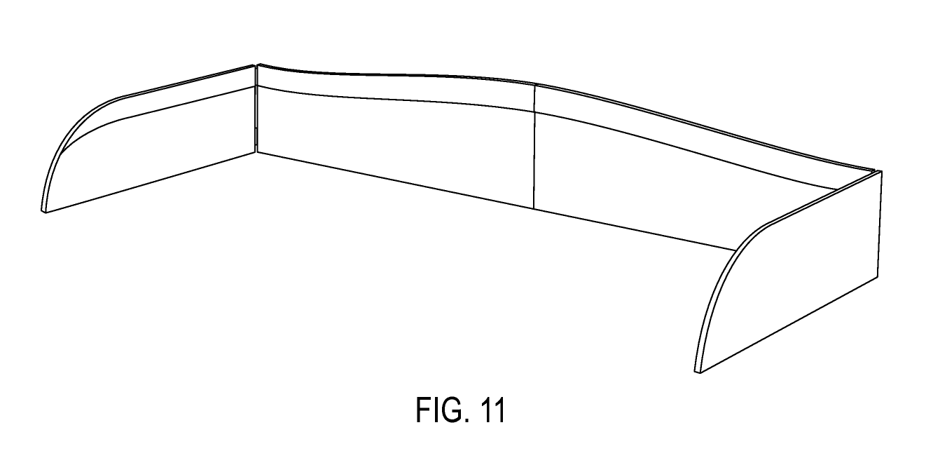

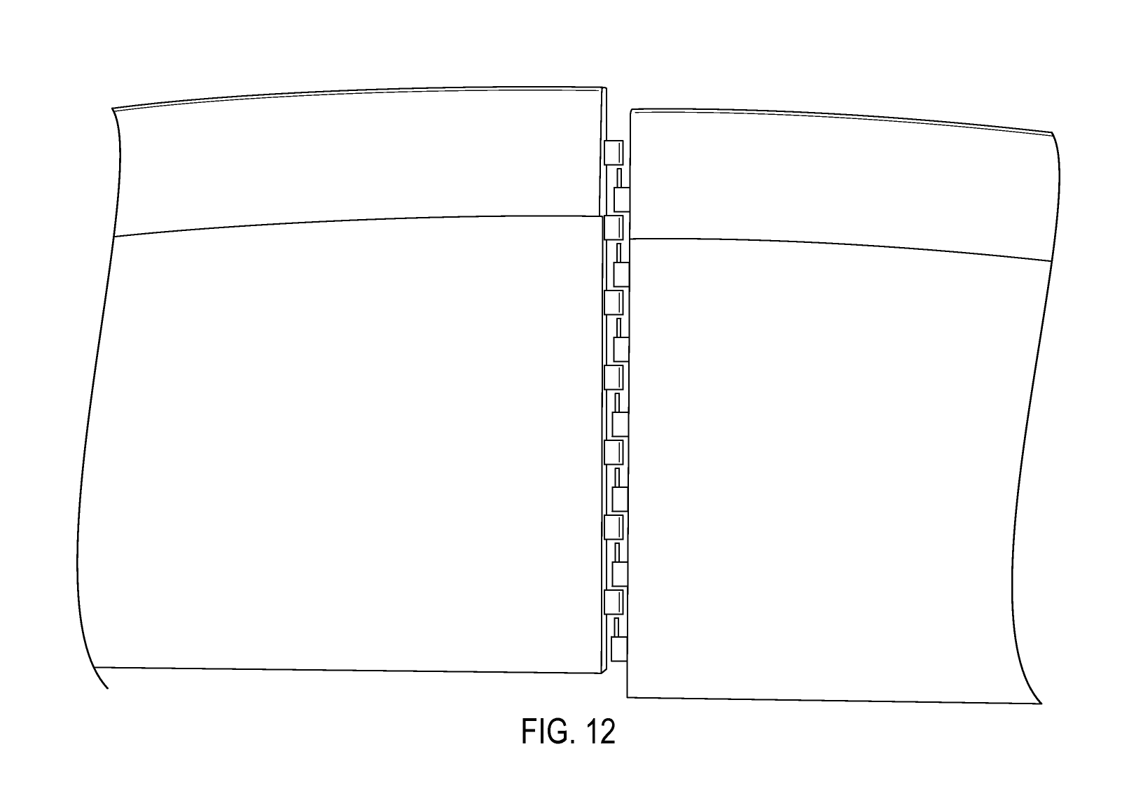

FIGS. 11 and 12 show a barrier system according to an alternative embodiment in which each of the side wall assemblies and rear wall assemblies are each respectively made of a single, continuous, shaped piece of material (e.g., plastic or other suitable material). FIG. 12 shows a particular lift off hinge that may be used to attach the rear wall assemblies together. In this embodiment, the front and side wall assemblies may be attached together respectively in any manner described above, and may include temporary fasteners, as described above, to facilitate attaching the wall assemblies to a substantially horizontal surface or other surface.

Composition of Barrier System and Wall Assembly Components

It should be understood in light of the above disclosure that the barrier system's various components may be made from any suitable material. Suitable materials include, but are not limited to: (1) plastic; (2) metal; (3) nylon fabric; (4) corn resin; (5) bamboo resin; (6) wood; (8) wire, such as vinyl covered wire; or (9) any other suitable material.

### CONCLUSION

Many modifications and other embodiments of the invention will come to mind to one skilled in the art to which this invention pertains having the benefit of the teachings presented in the foregoing descriptions and the associated drawings. For example, although various embodiments are described above as being adapted for use on substantially planar top and side surfaces, other embodiments may be adapted for use on other surfaces including non-planar surfaces. Also, although particular embodiments of the barrier system are described above as defining a substantially continuous barrier structure, other embodiments of the barrier system are non-continuous and, for example, may include gaps between the various wall assemblies. As a further example, although various embodiments are described above as including temporary fasteners, other embodiments may include permanent fasteners.

As yet a further example, although the various wall assemblies are described above as being substantially fixed in height, in other embodiments, suitable mechanical arrangements may be provided to allow users to selectively adjust the height of the wall assemblies. In addition, although various barrier system described herein are described as being adapted to be installed adjacent the perimeter edge regions of a horizontal surface, in other embodiments, the barrier system may be installed on a horizontal surface so that the barrier system is spaced apart from the perimeter of the horizontal surface. Also, although the wall assemblies described above are shown as being substantially planar, in other embodiments, the wall assemblies may be non-planar.

As another example, although various embodiments of the barrier system are described as including a plurality of wall assemblies that are attached together to form a continuous barrier structure, in other embodiments: (1) the barrier system may only include a single wall assembly; or (2) include two or more wall assemblies that are adapted to be used in a non-continuous arrangement. For example, the barrier system may include two side wall assemblies that are adapted to be positioned adjacent the perimeter edge regions on the top surface of a clothes washer or other appliance. In one such example, the side wall assemblies may be free standing, and the barrier system may not include any rear wall assemblies.

Accordingly, as will be understood by one skilled in the relevant field in light of this disclosure, the invention may take form in a variety of different mechanical and operational configurations.

Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

I claim:

1. A barrier system for use with an object that defines a top surface and a side surface, said barrier system comprising:
a wall assembly comprising a substantially planar barrier extending upwardly from an elongated base; and
one or more releasable fasteners that are sized, shaped and positioned to selectively attach said wall assembly to said top surface such that said barrier remains in a plane that is substantially perpendicular to said top surface.

2. The barrier system of claim 1, wherein said barrier comprises a frame that at least partly defines a central portion, and wherein said central portion comprises at least one material selected from a group consisting of a lattice, a net, and a substantially solid panel.

3. The barrier system of claim 1, wherein said one or more releasable fasteners comprises at least one fastener selected from a group consisting of: one or more magnets, one or more suction cups, one or more releasable adhesives, one or more hook-and-loop fasteners, and one or more clamps.

4. The barrier system of claim 1, wherein said one or more releasable fasteners comprises at least one magnet.

5. The barrier system of claim 1, wherein said wall assembly further comprises:
an extension projecting outwardly from said base along a plane that is substantially parallel to said side surface; and
a releasable extension fastener adapted to selectively attach said extension to said side surface.

6. The barrier system of claim 1, wherein said object is an appliance selected from a group consisting of a clothes washer, a clothes dryer, and a cooktop.

7. The barrier system of claim 1, wherein said object is an appliance selected from a group consisting of a clothes washer and a clothes dryer.

8. The barrier system of claim 1, further comprising:
a second wall assembly comprising a substantially planar second barrier extending upwardly from an elongated second base; and
one or more releasable second fasteners that are sized, shaped and positioned to selectively attach said second wall assembly to said top surface such that said second barrier remains in a plane that is substantially perpendicular to said top surface; and
an end connector assembly positioned between and adapted to releasably connect said first and second wall assemblies.

9. The barrier system of claim 8, wherein said end connector assembly further comprises a pivotable connection such that said first and second wall assemblies pivot relative to one another about a substantially vertical axis when connected.

10. The barrier system of claim 8, wherein said end connector assembly comprises at least one connector selected from a group consisting of a hinge, a magnet, an elastic band, a releasable adhesive, a hook-and-loop fastener, and an interlocking joint.

12. The barrier system of claim 8, wherein said first and second wall assemblies are selectively attached to said top surface near one or more perimeter edge regions of said top surface such that said assemblies form a substantially continuous barrier around at least a portion of said top surface.

13. The barrier system of claim 8, further comprising:
a third wall assembly comprising a substantially planar third barrier extending upwardly from an elongated third base; and
one or more releasable third fasteners that are sized, shaped and positioned to selectively attach said third wall assembly to said top surface such that said third barrier remains in a plane that is substantially perpendicular to said top surface; and
a second end connector assembly positioned between and adapted to releasably connect said second and third wall assemblies, to form a substantially U-shaped arrangement.

14. The barrier system of claim 13, further comprising:
a fourth wall assembly comprising a substantially planar fourth barrier extending upwardly from an elongated fourth base;
one or more releasable fourth fasteners that are sized, shaped and positioned to selectively attach said fourth wall assembly to said top surface such that said fourth barrier remains in a plane that is substantially perpendicular to said top surface; and
a third end connector assembly positioned between and adapted to releasably connect said third and fourth wall assemblies, to form a substantially U-shaped arrangement.

15. The barrier system of claim 14, wherein said barrier is a substantially continuous barrier and said elongated base is a lower portion of said barrier.

16. A barrier catch system for an appliance, said appliance comprising a side surface having a door therein, said barrier catch system comprising:
an elongated base;
a central portion extending outwardly from said elongated base, wherein said central portion is sized and shaped to catch articles that fall during the process of being inserted into or removed from said appliance through said door, and wherein said central portion comprises at least one material selected from a group consisting of a basket, a net, a lattice, and a substantially solid panel; and
one or more releasable fasteners that are sized, shaped and positioned to selectively attach said elongated base to said side surface beneath said door.

17. The barrier catch system of claim 16, wherein said one or more releasable fasteners are sized, shaped and positioned such that said central portion, when attached, remains in a plane disposed at an acute angle relative to said side surface.

18. The barrier catch system of claim 16, wherein said one or more releasable fasteners comprises at least one magnet.

19. The barrier catch system of claim 16, further comprising one or more side walls extending between said elongated base and said central portion.

20. The barrier catch system of claim 16, wherein said central portion is pivotably connected to said base.

21. A method of providing a selectively configurable barrier near one or more perimeter edge regions of a top surface of an appliance, said method comprising the steps of:
providing a first wall assembly having a substantially planar central portion extending upwardly from an elongated base, and wherein said first wall assembly further comprises one or more releasable fasteners that are sized, shaped and positioned to selectively attach said wall assembly to said top surface such that said central portion remains in a plane that is substantially perpendicular to said top surface;
providing a second wall assembly having a substantially planar second central portion extending upwardly from an elongated second base, and wherein said second wall assembly further comprises one or more releasable second fasteners that are sized, shaped and positioned to selectively attach said second wall assembly to said top surface such that said second central portion remains in a plane that is substantially perpendicular to said top surface;
instructing a user to connect said first and second wall assemblies with an end connector assembly provided and adapted to releasably connect said first and second wall assemblies; and
instructing said user to position said first and second wall assemblies near the one or more perimeter edge regions of said top surface in order to form a substantially continuous barrier around at least a portion of said top surface.

22. The method of claim 21, wherein said step of instructing a user further comprises the step of providing said end connector assembly with pivotable connection such that said first and second wall assemblies pivot relative to one another about a substantially vertical axis when connected.

23. The method of claim 21, further comprising the steps of:
providing a third wall assembly comprising a substantially planar third central portion extending upwardly from an elongate third base, and wherein said third wall assembly further comprises one or more releasable third fasteners that are sized, shaped and positioned to selectively attach said third wall assembly to said top surface such that said third central portion remains in a plane that is substantially perpendicular to said top surface;
instructing a user to connect said second and third wall assemblies with a second end connector assembly provided and adapted to releasably connect said second and third wall assemblies; and
instructing said user to position said first and second and third wall assemblies adjacent said top surface in order to form a substantially continuous and U-shaped barrier around at least a portion of said top surface.
